(19) United States
(12) Patent Application Publication
(10) Pub. No.: US 2022/0102752 A1
(43) Pub. Date: Mar. 31, 2022

(54) LITHIUM ION BATTERY WHICH CAN BE IMPLANTED INTO AN OPTICAL SENSOR THROUGH AN OPTICAL FIBER AND THE MANUFACTURE METHOD

(71) Applicant: Zhejiang University, Hangzhou (CN)

(72) Inventors: Sailing HE, Hangzhou (CN); Huaguan LIN, Hangzhou (CN)

(21) Appl. No.: 17/546,312

(22) Filed: Dec. 9, 2021

Related U.S. Application Data
(63) Continuation of application No. PCT/CN2021/135888, filed on Dec. 7, 2021.

(30) Foreign Application Priority Data
May 29, 2021 (CN) 202110596028.6

(51) Int. Cl. H01M 10/0525; H01M 4/36

(52) U.S. Cl. CPC H01M 10/0525; H01M 10/058; H01M 4/366

(57) ABSTRACT

The invention discloses a lithium ion battery structure where an internal optical sensor can be implanted through an optical fiber. It is a battery sensing technology. A soft packed lithium-ion battery structure through which an internal optical sensor can be implanted through an optical fiber to monitor the changes of some specified parameters during the use of soft packed lithium-ion battery, including: packaging film, cell, sensing element and transmission optical fiber; a hard shell lithium ion battery structure through which an internal optical sensor can be implanted through an optical fiber, including: battery shell, battery cover, cell, sensing element and transmission optical fiber.

### CROSS-REFERENCE TO RELATED APPLICATIONS

This application is a continuation of International Application No. PCT/CN2021/135888, filed on Dec. 7, 2021, which claims the benefit of priority from Chinese Patent Application No. 202110596028.6, filed on May 29, 2021. The content of the aforementioned applications, including any intervening amendments thereto, are incorporated herein by reference.

### FIELD OF TECHNOLOGY

This invention relates to the field of battery sensing technology, in particular to a lithium ion battery which can be implanted into an optical sensor through an optical fiber and the manufacture method.

### BACKGROUND TECHNOLOGY

With the development of new energy industry, the industrial scale of lithium ion battery is also growing rapidly, and the capacity and energy density of lithium ion battery are constantly improving, at the same time, the safety of lithium ion battery has drawn particular attention. At present, there are three packaging methods commonly used in the market for lithium ion batteries, namely, the flexible package of aluminum-plastic film, the cylindrical and square battery of steel shell or aluminum shell and other hard metal shell packaging. The chemical and thermal states of lithium ion battery are constantly changing during the use of it, including the migration and transformation of lithium compounds, internal temperature of lithium ion battery, internal pressure of lithium ion battery and different kinds and concentrations of gases produced by electrolyte decomposition during the thermal runaway of lithium ion batteries. Effective monitoring of these parameters is helpful to judge the working status and health status of lithium ion batteries. In addition, in a variety of battery sensing schemes, optical fiber sensor has the advantages of small structure, anti-electromagnetic interference, long life, high sensitivity, and can effectively characterize the above parameters of the battery state. However, most optical fiber sensors need to be placed in the internal environment of the battery to realize effective sensing function.

### INVENTION CONTENT

Based on the limitations of existing technology, the purpose of this invention is to provide a lithium ion battery which can be implanted into an optical sensor through an optical fiber and the manufacture method: on the premise of ensuring the performance and tightness of lithium ion battery, an optical sensing element is implanted in the lithium ion battery through an optical fiber.

This invention states a lithium ion battery which can be implanted into an optical sensor through an optical fiber and the manufacture method.

A lithium-ion battery that can be implanted into an optical sensor through transmission optical fiber, includes packing film, cell, sensing element, demodulation module and transmission optical fiber.

The packaging film is the packaging material of the cell, it could be a commercial aluminum-plastic film material.

The cell is arranged inside the packaging film, which is provided with a positive pole ear and a negative pole ear; the positive pole ear is used to lead out the positive pole of the cell, the negative pole ear is used to lead out the negative pole of the cell.

The positive pole ear is affixed with a layer of positive pole ear glue, the negative ear is affixed with a layer of negative pole ear glue.

The pole ear glue is a layer of polymer glue, which bond with the packaging film, realizing the sealing of the positive and negative pole ears with the soft packed lithium-ion battery.

The sensing element is a device based on the principle of optical sensing, used to monitor the change of the parameters to be measured inside the soft packed lithium-ion battery.

The sensing element is arranged on the upper surface of the cell and connected with one end of the transmission optical fiber.

The transmission optical fiber is used to transmit the probe light to the sensing element inside the soft packed lithium-ion battery, and to output the signal light containing the specified parameter information to be measured to the demodulation module.

The other end of the transmission optical fiber is contacted with first optical fiber connector.

The demodulation module is used to provide the probe light required by the sensing element and to receive and analyze the returned signal light.

In one implementation of this embodiment, the packaging film could be the aluminum-plastic film.

The aluminum-plastic film includes nylon layer, aluminum layer and heat seal layer. The nylon layer is responsible for maintaining the smooth and stable shape structure of the entire aluminum plastic film; the aluminum foil layer is responsible for isolating moisture from outside; and the heat sealing layer is responsible for sealing the edge of the whole soft packed lithium-ion battery and preventing electrolyte leakage.

In one implementation of this embodiment, the sensing element could be a photo-acoustic pool based on gas photo-acoustic spectroscopy technology or a quartz tuning fork; or a cavity-enhanced chamber or multi-pass cell based on absorption spectroscopy; or an optical fiber or optical waveguide chip which diffused by gas.

The parameters to be measured inside the packed lithium-ion battery include one or more of the following: the migration and transformation of lithium compounds, internal temperature of lithium ion battery, internal pressure of lithium ion battery and different kinds and concentrations of gases produced by electrolyte decomposition during the thermal runaway of lithium ion batteries.

In one implementation of this embodiment, the transmission fiber could be a commercial single-mode fiber with a core layer diameter of 9 microns and a cladding layer diameter of 125 microns. The diameter of the core layer of the concave area of the transmission optical fiber which be treated by tapering is 9 microns, and the diameter of the cladding layer could be 40 microns.

A layer of polymer glue coated on the concave area of the transmission optical fiber after tapered treatment is used to melt and bond with the packaging film, so as to achieve the sealing of the transmission optical fiber and the packaging film.

The concave area is formed by tapering treatment.

The number of transmission optical fiber could be one or more.

In one implementation of this embodiment, the optical connector can be a Ferrule Connector.

In one implementation of this embodiment, the probe light emitted by the light source inside the demodulation module passes through the transmission optical fiber to the sensing element, and the returned signal light is analyzed and processed through the same transmission optical fiber back to the demodulation module.

In another implementation of this embodiment, the number of transmission fibers is two, specifically, the probe light emitted by the light source inside the demodulation module passes the first transmission optical fiber to the sensing element, and the signal light is analyzed and processed through the second transmission optical fiber back to the demodulation module.

A fabrication method of the lithium-ion battery through which an internal optical sensor can be implanted through an optical fiber, including:

aluminum-plastic film, cell, sensing element and transmission optical fiber; The cell is provided with a positive pole ear and a negative pole ear, the positive pole ear is affixed with a layer of positive pole ear glue, the negative pole ear is affixed with a layer of negative pole ear glue; the sensing element is connected with one end of the transmission optical fiber; a segment of the transmission optical fiber is tapered, and the surface of this segment of the transmission optical fiber after tapering is coated with a polymer adhesive, the other end of the transmission optical fiber is provided with an optical fiber connector;

A pit which can be put into the cell is pressed on an aluminum-plastic film, a piece of an aluminum-plastic film with a pit could be got after cutting;

The cell is placed in the pit of the aluminum-plastic film, and a part of the positive pole ear and a part of the negative pole ear of the cell is exposed outside the aluminum-plastic film and the positive electrode ear glue and the negative electrode ear glue are in contact with the edge of the aluminum-plastic film;

The sensing element which is connected with one end of the transmission optical fiber is placed into the aluminum-plastic film, then the sensing element is fixed on the cell through adhesive tape or other ways, and the concave area of the transmission optical fiber which coated with polymer glue is contacted with the aluminum-plastic film edge;

Folding the aluminum-plastic film along the broken line after folding, the edge of the folded aluminum plastic film located at the upper layer is in contact with the segment of transmission optical fiber which coated with polymer glue, the positive pole ear glue and the negative pole ear glue;

Put the aluminum-plastic film containing the cell, sensing element and transmission optical fiber in a top side sealing machine for left side sealing and top sealing, then the electrolyte solution is injected into the right opening of the aluminum-plastic film, and then the right sealing;

After the cell is first charged and activated, the generated gas is squeezed into the right area of the aluminum-plastic film by extrusion, and then exhaust the generated gas and cut off the excess aluminum-plastic film, and seal the right side again.

A hard shell lithium ion battery structure through which an internal optical sensor can be implanted through an optical fiber, including: battery shell, battery cover, cell, sensing element and transmission optical fiber.

The bottom of the battery shell is provided with an insulating cushion layer;

The insulating cushion layer is used to prevent the bottom of the cell from contacting the battery shell directly, which will result in a short circuit.

The cell is located inside the battery shell, the bottom of which is in contact with the insulating cushion layer, the positive pole ear located in the cell is connected with the positive terminal of the battery cover, the negative pole ear located in the cell is connected with the negative terminal of the battery cover.

The battery cover is provided with a vent, a positive terminal, a negative terminal and a reduced pressure exhaust area;

The vent is a millimeter level through hole for exhausting the gas generated inside the battery after the activation of the cell for the first time, and then the vent will be sealed by laser welding;

The positive terminal and the positive pole ear are in direct contact with the battery cover, and the negative terminal and the negative pole ear are isolated from the battery cover through a layer of insulation layer, this insulation layer could be a layer of polymer material;

The reduced pressure exhaust area is used for exhausting gas when the internal pressure of the hard shell lithium ion battery is too high;

The sensing element is a device based on the principle of optical sensing, used to monitor the change of the parameters to be measured inside the soft packed lithium-ion battery;

The sensing element is arranged on the upper surface of the cell and connected with one end of the transmission optical fiber;

The transmission optical fiber is used to transmit the probe light to the sensing element inside the soft packed lithium-ion battery, and to output the signal light containing the specified parameter information to be measured to the demodulation module;

The other end of the transmission optical fiber is contacted with first optical fiber connector;

The demodulation module is used to provide the probe light required by the sensing element and to receive and analyze the returned signal light.

In one implementation of this embodiment, the battery shell is a square-shaped hard shell container without a top cover, which could be made of steel or aluminum material;

In one implementation of this embodiment, the battery cover could be a steel material plate or an aluminum material plate, which can be sealed with the battery shell by laser welding;

In one implementation of this embodiment, the reduced pressure exhaust area could be an aluminum material area whose thickness is less than the battery cover;

In one implementation of this embodiment, the transmission optical fiber is a single-mode optical fiber with a metal coating, which is connected to the sensing element inside the hard shell lithium ion battery through a hole reserved on the upper cover of the battery, and then the hole is sealed by laser welding.

### Beneficial Effects of the Invention

The implanted optical sensor has advantages of small size, high precision and anti-electromagnetic interference, which can effectively monitor the parameters of lithium ion battery; Depending on the parameters to be monitored, the number of optical sensors can be multiple or a sensor chip integrating multiple sensing functions, and the number of transmission fibers can be one or more; The transmission optical fiber can effectively realize the sealing of flexible package or hard shell battery by coating polymer glue or metal, and ensure the service life of the battery.

### FIGURES AND FIGURE LEGENDS

FIG. 1 is a structural schematic diagram of a soft packed lithium-ion battery which can be implanted into an optical sensor through an optical fiber.

FIG. 2 is a schematic diagram of the position of aluminum plastic film and transmission optical fiber in the soft packed lithium-ion battery through which an internal optical sensor can be implanted through an optical fiber.

FIGS. 3a-3f is a flow chart of a fabrication method of the soft packed lithium-ion battery through which an internal optical sensor can be implanted through an optical fiber.

FIG. 4 is a structural schematic diagram of a hard shell lithium ion battery which can be implanted into an optical sensor through an optical fiber.

### SPECIFIC IMPLEMENTATION MODE

The technical scheme of the invention will be described in combination with the attached figures of the embodiment of the invention.

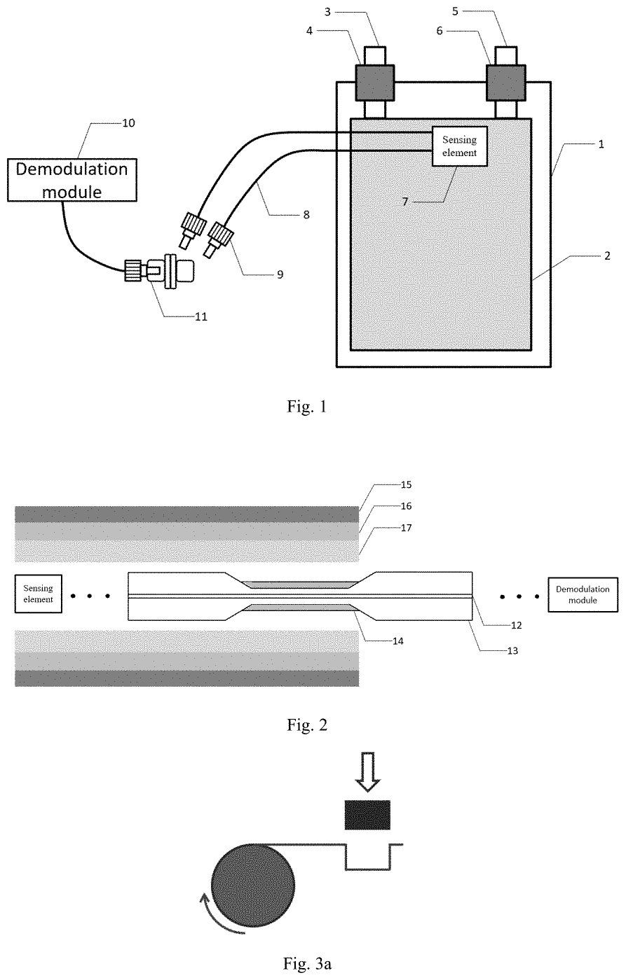

FIG. 1 is a structural schematic diagram of a soft packed lithium-ion battery which can be implanted into an optical sensor through an optical fiber.

As shown in the FIG. 1, the soft packed lithium-ion battery that can be implanted into an optical sensor through transmission optical fiber includes packing film 1, cell 2, sensing element 7, demodulation module 10 and transmission optical fiber 8. Through which in, the cell 2 is arranged inside the packaging film 1, the cell 2 is provided with a positive pole ear 3 and a negative pole ear 5, the positive pole ear 3 is affixed with a layer of positive pole ear glue 4, the negative ear 5 is affixed with a layer of negative pole ear glue 6. The sensing element 7 is arranged on the upper surface of the cell 2 and connected with one end of the transmission optical fiber 8, the other end of the transmission optical fiber is contacted with first optical fiber connector 9. The second optical fiber connector 11 is arranged at the end of the transmission fiber of the demodulation module 10.

Specifically, the packaging film 1 is the packaging material of the cell 2. In this embodiment, it could be a commercial aluminum-plastic film material, which has three layers structure: nylon layer, aluminum foil layer and heat sealing layer, layers are pressed and bonded by bonding additives. In different implementations of this embodiment, the thickness of the aluminum-plastic film can be one of 88 microns, 113 microns, or 153 microns.

The cell 2 has two production methods of winding type and folding type. In different embodiments of the present embodiment, the cell 2 can be a winding cell or a laminated cell.

The positive pole ear 3 and the negative pole ear 5 are conductive metal materials, the positive pole ear 3 is used to lead out the positive pole of the cell 2, the negative pole ear 5 is used to lead out the negative pole of the cell 2. In one implementation of this embodiment, the positive pole ear 3 could be aluminum metal and the negative pole ear 5 could be nickel metal.

The positive pole ear glue 4 and the negative pole glue 6 are both a layer of polymer glue, which bond with the heat sealing layer in the aluminum plastic film during the thermal packaging of the cell 2, realizing the sealing of the positive and negative pole ears.

The sensing element 7 is a device based on the principle of optical sensing, used to monitor the change of the parameters to be measured inside the soft packed lithium-ion battery. In this embodiment, the sensing element 7 could be a small photoacoustic pool based on gas photoacoustic spectroscopy technology or a quartz tuning fork; or a cavity-enhanced chamber or multi-pass cell based on absorption spectroscopy; or an optical fiber or optical waveguide chip which diffused by gas. The parameters to be measured inside the soft packed lithium-ion battery include one or more of the following: the migration and transformation of lithium compounds, internal temperature of lithium ion battery, internal pressure of lithium ion battery and different kinds and concentrations of gases produced by electrolyte decomposition during the thermal runaway of lithium ion batteries.

The transmission optical fiber 8 is used to transmit the probe light to the sensing element 7 inside the soft packed lithium-ion battery, and to output the signal light containing the specified parameter information to be measured to the demodulation module 10. In this embodiment, the signal light can be either reflected light or transmitted light; the number of transmission optical fibers 8 can be one or more. In other embodiments, the number of transmission optical fibers 8 may be other suitable number depending on the number of parameters to be monitored.

The first optical fiber connector 9 and the second optical fiber connector 11 is used to connect two transmission optical fibers. In this embodiment, the first optical fiber connector 9 and the second optical fiber connector 11 is used to connect the transmission fiber of the demodulation module to the transmission optical fiber of the sensing element 7, specifically, the first optical fiber connector 9 and the second optical fiber connector 11 can be a Ferrule Connector. In other embodiments of the present embodiment, the optical coupling method of the two transmission optical fibers could be other optical coupling method rather than limited to the first optical fiber connector 9 and the second optical fiber connector 11.

The demodulation module 10 is used to provide the probe light required by the sensing element 7 and to receive and analyze the returned signal light. In one implementation of this embodiment, the number of the transmission optical fiber 8 is one, specifically, the probe light emitted by the light source inside the demodulation module 10 passes through the transmission optical fiber to the sensing element, and the returned signal light is analyzed and processed through the same transmission optical fiber 8 back to the demodulation module 10; Optionally, in another implementation of this embodiment, the number of transmission fibers is two, specifically, the probe light emitted by the light source inside the demodulation module 10 passes the first transmission optical fiber to the sensing element 7, and the signal light is analyzed and processed through the second transmission optical fiber back to the demodulation module 10. In other embodiments of the present embodiment, the light source could be external to the demodulation module 10 rather than built-in in the demodulation module 10.

FIG. 2 is a schematic diagram of the position of aluminum plastic film and transmission optical fiber in the soft packed lithium-ion battery through which an internal optical sensor can be implanted through an optical fiber

As shown in the FIG. 2, the connection between the transmission optical fiber 8 and the packaging film 1 is provided with a concave area 25; the surface of the concave area 25 is coated with polymer adhesive 14, the polymer glue 14 is used to melt and bond with the packaging material to achieve the sealing of the transmission optical fiber 8 and the packaging film 1. Specifically, the concave area 25 is formed by a tapered treatment.

The surface of the concave area is coated with polymer adhesive 14, the polymer glue is used to melt and bond with the packaging material to achieve the sealing of the transmission optical fiber 8 and the packaging film 1.

The aluminum-plastic film includes nylon layer 15, aluminum layer 16 and heat seal layer 17. The transmission fiber consists of core layer 12 and cladding layer 13.

Specifically, in the aluminum-plastic film, the nylon layer 15 is responsible for maintaining the smooth and stable shape structure of the entire aluminum plastic film, the aluminum foil layer 16 is responsible for isolating moisture from outside, and the heat sealing layer 17 is responsible for sealing the edge of the whole soft packed lithium-ion battery and preventing electrolyte leakage. In this embodiment, the material of the heat sealing layer 17 could be polypropylene. In one embodiment of the present embodiment, the thickness of the aluminum-plastic film is 153 microns.

In this embodiment, the transmission fiber could be a commercial single-mode fiber with a core layer diameter of 9 microns and a cladding layer diameter of 125 microns. The diameter of the core layer of the concave area of the transmission optical fiber which be treated by tapering is 9 microns, and the diameter of the cladding layer could be 40 microns.

In the thermal packaging of the soft packed lithium-ion battery, a layer of polymer glue coated on the segment of the transmission optical fiber after tapered treatment is used to melt and bond with the heat sealing layer in the aluminum plastic film, so as to achieve the sealing of the packaging material at the position of the transmission optical fiber.

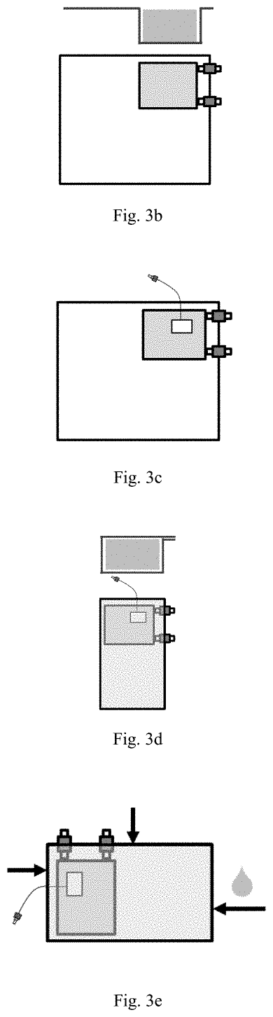

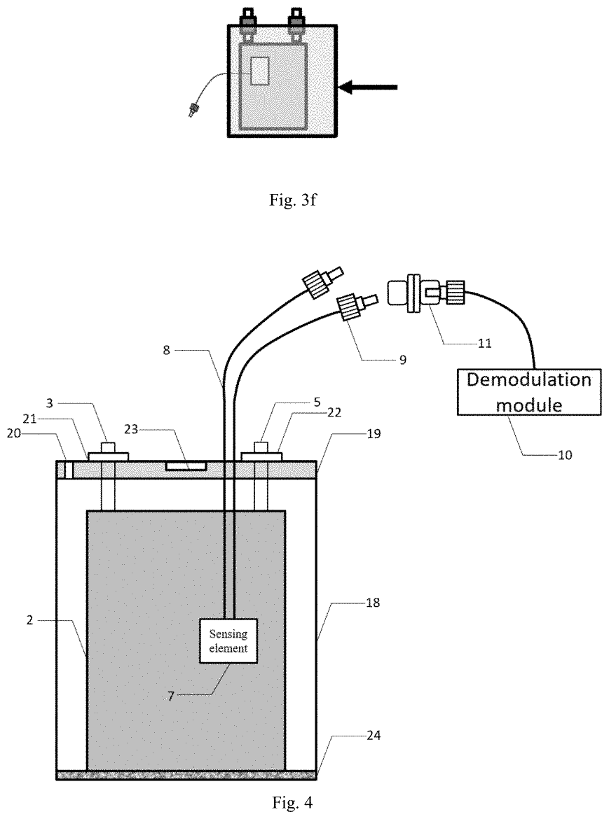

FIG. 3 is a flow chart of a fabrication method of the soft packed lithium-ion battery through which an internal optical sensor can be implanted through an optical fiber.

FIG. 3a shows a schematic diagram of making a pit on the aluminum-plastic film, specifically, a pit which can be put into the cell is pressed on a flat aluminum-plastic film by stamping die, then a piece of an aluminum-plastic film with a pit could be got after cutting. In this embodiment, the dimensions of the stamping die are close to the cell. In other implementations of this embodiment, the number of pits can be two depending on the size of the cell.

FIG. 3b shows the schematic diagram of the front and top view of the aluminum-plastic film after placing the cell, specifically, the size of the pit on the aluminum-plastic film is slightly larger than the size of the cell, and part of the positive pole ear and negative pole ear of the cell is exposed to the outside, and the positive pole ear and negative pole ear are in contact with the edge of the aluminum-plastic film.

FIG. 3c shows the schematic diagram of the top view of the aluminum-plastic film after placing the sensing element, specifically, the sensing element is located on the upper surface of the cell, which can be fixed on the cell by means of adhesive tape; one end of the transmission optical fiber is connected to the sensing element, and the other end has the first fiber optic connector and is exposed outside, the segment of the transmission optical fiber coated with polymer glue is in contact with the edge of the aluminum-plastic film.

FIG. 3d shows a schematic diagram of the front and top view of the aluminum plastic film folded along the broken line, after folding, the edge of the folded aluminum plastic film located at the upper layer is in contact with the segment of transmission optical fiber which coated with polymer glue, the positive pole ear glue and the negative pole ear glue.

FIG. 3e shows the schematic diagram of left sealing, top sealing, liquid injection and right sealing steps, specifically, left sealing and top sealing are finished in the top side sealing machine. When sealing on the left side, the upper head and the lower head with a certain temperature are pressed together on the left side of the aluminum-plastic film, so that the thermal sealing layer in the aluminum-plastic film and the polymer glue coated on the segment of the transmission optical fiber could melt and bond, so as to achieve the left sealing of the aluminum-plastic film; When sealing on the top side, the upper head and the lower head with a certain temperature are pressed together on the top of the aluminum plastic film, so that the hot sealing layer in the aluminum-plastic film, the positive pole ear glue and negative ear glue could melt and bond, so as to realize the upper sealing of the aluminum-plastic film. Liquid injection is carried out in the drying room, specifically, electrolyte solution is injected into the aluminum-plastic film from the remaining right opening side, and then sealing the right opening side, which is named as the first right sealing. The implementation method of the first right sealing is the same as that of the left sealing.

FIG. 3f shows the schematic diagram of the second right sealing. Specifically, after the cell is first charged and activated, a certain amount of gas is generated, which can be filled in the right side of the aluminum-plastic film by extrusion or other ways and discharged by pumping or other ways. After that, the excess aluminum-plastic film on the right side will be cut off. At last, sealing the right side of the residue aluminum-plastic film, which is named as the second right sealing. The implementation method of the second right sealing is the same as that of the left sealing.

FIG. 4 is a structural schematic diagram of a hard shell lithium ion battery which can be implanted into an optical sensor through an optical fiber.

As shown in the FIG. 4, the hard shell lithium ion battery structure through which an internal optical sensor can be implanted through an optical fiber, including: battery shell 18, battery cover 19, cell 2, sensing element 7 and transmission optical fiber 8. Specifically, the bottom of the battery shell 18 is provided with an insulating cushion layer 24; the battery cover 19 is provided with a vent 20, a positive terminal 21, a negative terminal 22 and a reduced pressure exhaust area 23; the cell 2 is located inside the battery shell 18, the bottom of which is in contact with the insulating cushion layer 24, the positive pole ear 3 located in the cell is connected with the positive terminal 21 of the battery cover, the negative pole ear 4 located in the cell is connected with the negative terminal 22 of the battery cover. The sensing element 7 is connected to one end of the transmission optical fiber 8, and the other end of the transmission optical fiber 8 is provided with the first optical connector 9. The second optical connector 11 is arranged on the end of the transmission optical fiber of demodulation module 10.

Specifically, the battery shell 18 is a square-shaped hard shell container without a top cover, which could be made of steel or aluminum material. In this embodiment, the battery shell 18 can be a hard shell of aluminum material with a thickness of 2 mm.

The insulating cushion layer 24 is used to prevent the bottom of the cell 2 from contacting the battery shell 18 directly, which will result in a short circuit. In this embodiment, the insulating cushion layer could be a layer of polymer material with a thickness of 50 microns.

The battery cover 19 could be a steel material plate or an aluminum material plate, which can be sealed with the battery shell by laser welding. In this embodiment, the battery cover could be an aluminum plate of 2 mm thickness. The vent is a millimeter level through hole for exhausting the gas generated inside the battery after the activation of the cell for the first time, and then the vent will be sealed by laser welding. The positive terminal 21 and the positive pole ear 3 are in direct contact with the battery cover 19, and the negative terminal 22 and the negative pole 4 ear are isolated from the battery cover through a layer of insulation layer, this insulation layer could be a layer of polymer material; The reduced pressure exhaust area is used for exhausting gas when the internal pressure of the hard shell lithium ion battery is too high, in this embodiment, the reduced pressure exhaust area could be an aluminum material area whose thickness is less than the battery cover.

The functions and parameters of the cell 2, sensing element 7 and demodulation module 10 have been described in the soft packed lithium-ion battery described in FIG. 1 and will not be described again.

In one implementation of this embodiment, the transmission optical fiber 8 is a single-mode optical fiber with a metal coating, which is connected to the sensing element inside the hard shell lithium ion battery through a hole reserved on the upper cover of the battery, and then the hole is sealed by laser welding.

What is claimed is:

1. A lithium-ion battery structure through which an internal optical sensor can be implanted through an optical fiber to monitor the changes of some specified parameters during the use of soft packed lithium-ion battery, its characteristic is that, including: packaging film, cell, sensing element, demodulation module and transmission optical fiber;
the packaging film is the packaging material of the cell;
the cell is located inside the packaging film, the cell is provided with a positive pole ear and a negative pole ear; the positive pole ear is used to lead out the positive pole of the cell, and the negative pole ear is used to lead out the negative pole of the cell;
the positive pole ear is affixed with a layer of positive pole ear glue, the negative pole ear is affixed with a layer of negative pole ear glue;
the positive pole ear glue and the negative pole ear glue are contacted with the packaging film edge, for realizing the sealing of the place of positive electrode ear and the negative electrode ear;
the sensing element is a device based on the principle of optical sensing, used to monitor the change of the parameters to be measured inside the soft packed lithium-ion battery; the sensing element is arranged on the surface of the cell;
the transmission optical fiber is used for transmitting a probe light to the sensing element and transmitting the signal light which containing the information of the parameters to be measured to the demodulation module. Depending on the number of sensing element, the number of the transmission optical fiber could be one or more.

2. According to the lithium-ion battery mentioned in claim of right 1, its characteristic is that, the sensing element could be a photoacoustic pool based on gas photoacoustic spectroscopy technology or a quartz tuning fork; or a cavity-enhanced chamber or multi-pass cell based on absorption spectroscopy; or an optical fiber or optical waveguide chip which diffused by gas;
the parameters to be measured inside the lithium-ion battery include one or more of the following: the migration and transformation of lithium compounds, internal temperature of lithium ion battery, internal pressure of lithium ion battery and different kinds and concentrations of gases produced by electrolyte decomposition during the thermal runaway of lithium ion batteries.

3. According to the lithium-ion battery mentioned in claim of right 1, its characteristic is that, the connection between the transmission optical fiber and the packaging film is provided with a concave area; the surface of the concave area is coated with polymer adhesive, the polymer glue is used to melt and bond with the packaging material to achieve the sealing of the transmission optical fiber and the packaging film.

4. According to the lithium-ion battery mentioned in claim of right 1, its characteristic is that, the concave area is formed by tapering treatment.

5. According to the lithium-ion battery mentioned in claim of right 1, its characteristic is that, the probe light emitted by the light source inside the demodulation module passes through the transmission optical fiber to the sensing element, and the returned signal light is analyzed and processed through the transmission optical fiber back to the demodulation module.

6. According to the lithium-ion battery mentioned in claim of right 1, its characteristic is that, the probe light emitted by the light source inside the demodulation module could also pass the first transmission optical fiber to the sensing element, and the signal light is analyzed and processed through the second transmission optical fiber back to the demodulation module.

7. A manufacturing method of the lithium-ion battery according to claim of right 1, its characteristic is that, including:
aluminum-plastic film, cell, sensing element and transmission optical fiber; The cell is provided with a positive pole ear and a negative pole ear, the positive pole ear is affixed with a layer of positive pole ear glue, the negative pole ear is affixed with a layer of negative pole ear glue; the sensing element is connected with one end of the transmission optical fiber; a segment of the transmission optical fiber is tapered, and the surface of this segment of the transmission optical fiber after tapering is coated with a polymer adhesive, the other end of the transmission optical fiber is provided with an optical fiber connector;
a pit which can be put into the cell is pressed on an aluminum-plastic film, a piece of an aluminum-plastic film with a pit could be got after cutting;
the cell is placed in the pit of the aluminum-plastic film, a part of the positive pole ear and a part of the negative pole ear of the cell is exposed outside the aluminum-plastic film and the positive electrode ear glue and the negative electrode ear glue are in contact with the edge of the aluminum-plastic film;
the sensing element which is connected with one end of the transmission optical fiber is placed into the aluminum-plastic film, then the sensing element is fixed on the cell through adhesive tape, and the concave area of the transmission optical fiber which coated with polymer glue is contacted with the aluminum-plastic film edge;
folding the aluminum-plastic film along the broken line after folding, the edge of the folded aluminum plastic film located at the upper layer is in contact with the segment of transmission optical fiber which coated with polymer glue, the positive pole ear glue and the negative pole ear glue;
put the aluminum-plastic film containing the cell, sensing element and transmission optical fiber in a top side sealing machine for left side sealing and top sealing, then the electrolyte solution is injected into the right opening of the aluminum-plastic film, and then the right sealing;
after the cell is first charged and activated, the generated gas is squeezed into the right area of the aluminum-plastic film by extrusion, and then exhaust the generated gas and cut off the excess aluminum-plastic film, and seal the right side again.

8. A hard shell lithium ion battery structure through which an internal optical sensor can be implanted through an optical fiber, including: battery shell, battery cover, cell, sensing element and transmission optical fiber;
the bottom of the battery shell is provided with an insulating cushion layer to prevent direct contact between the bottom of the cell and the battery shell, which resulting in a short circuit;
the cell is located inside the battery shell and the cell is provided with a positive pole ear and a negative pole ear, the bottom of which is in contact with the insulating cushion layer;
the battery cover is provided with a vent, a positive terminal, a negative terminal and a reduced pressure exhaust area;
the positive pole ear is used to lead out the positive pole of the cell and is connected with the positive terminal of the battery cover; the negative pole ear is used to lead out the negative pole of the cell and is connected with the negative terminal of the battery cover.
the vent is a millimeter level through hole for exhausting the gas generated inside the battery after the activation of the cell for the first time;
the positive terminal and the positive pole ear are in direct contact with the battery cover, and the negative terminal and the negative pole ear are isolated from the battery cover through a layer of insulation layer;
the reduced pressure exhaust area is used for exhausting gas when the internal pressure of the hard shell lithium ion battery is too high;
the sensing element is a device based on the principle of optical sensing, used to monitor the change of the parameters to be measured inside the hard shell lithium ion battery;
the sensing element could be a photoacoustic pool based on gas photoacoustic spectroscopy technology or a quartz tuning fork; or a cavity-enhanced chamber or multi-pass cell based on absorption spectroscopy; or an optical fiber or optical waveguide chip which diffused by gas; the sensing element is arranged on the surface of the cell;
the transmission optical fiber is used for transmitting a probe light to the sensing element and transmitting the signal light which containing the information of the parameters to be measured to the demodulation module. Depending on the number of sensing element, the number of the transmission optical fiber could be one or more.

8. According to the hard shell lithium ion battery mentioned in claim of right 7, its characteristic is that, the battery shell is a square-shaped hard shell container without a top cover, and the material could be steel or aluminum;
the battery cover could be made of steel material plate or aluminum material plate, which is connected with the battery shell by laser welding to achieve sealing;
the vent is sealed by laser welding after completing the exhaust function;
the reduced pressure exhaust area could be an aluminum material area whose thick is less than the battery cover.

9. According to the hard shell lithium ion battery mentioned in claim of right 7, its characteristic is that, the transmission optical fiber is a single-mode optical fiber with a metal coating, connected to the sensing element inside the hard shell lithium ion battery by passing through the hole reserved on the battery cover, and then the hole is sealed by laser welding.
